(19) United States
(12) Patent Application Publication
(10) Pub. No.: US 2013/0044061 A1
(43) Pub. Date: Feb. 21, 2013

(54) METHOD AND APPARATUS FOR PROVIDING A NO-TAP ZONE FOR TOUCH SCREEN DISPLAYS

(71) Applicant: Daniel L. Ashbrook, Santa Monica, CA (US)

(72) Inventor: Daniel L. Ashbrook, Santa Monica, CA (US)

(73) Assignee: Nokia Corporation, Espoo (FI)

(21) Appl. No.: 13/210,766

(22) Filed: Aug. 16, 2011

(51) Int. Cl. G06F 3/041

(52) U.S. Cl. 345/173

(57) ABSTRACT

An apparatus, method, and computer program product are described that provide for the designation of a no-tap zone on a touch screen display, in which at least a contact aspect of the user input entered in the no-tap zone is disregarded. The apparatus includes at least one processor and memory including computer program code that are designed to cause the apparatus to provide for display of a first area and a second area each configured to receive user input, and to designate a portion of the first area as a no-tap zone, where at least a contact aspect of user input would be disregarded. The no-tap zone may border at least a portion of the second area. In this way, accidental input gestures made in the no-tap zone may be ignored, and the user can proceed with his interaction with the touch screen display without effecting any unintended operations.

### TECHNOLOGICAL FIELD

Embodiments of the present invention relate generally to designating an area on a touch screen display that is unresponsive to accidental inputs. In particular, embodiments of the present invention relate to an apparatus and method for providing a no-tap zone on a touch screen display in which at least a contact aspect of the user input entered in the no-tap zone is disregarded.

### BACKGROUND

Touch screen displays are becoming more prevalent in society. From commercial devices, such as in cash registers for facilitating retail transactions, to personal devices, such as cellular telephones and other mobile devices, touch screen displays are commonly used to receive input from users.

In addition, the increased functionality of the devices in which the touch screen displays are used has made it common for multiple user interface elements to be presented to the user at the same time on different parts of the touch screen display.

Accordingly, it may be desirable to provide an improved mechanism by which a user may interact with different areas of a touch screen display that protects against accidental inputs from the user.

### BRIEF SUMMARY OF EXAMPLE EMBODIMENTS

Accordingly, embodiments of an apparatus, method, and computer program product are described that provide for an improved mechanism for receiving touch input from a user by providing for the designation of a no-tap zone on a touch screen display, in which at least a contact aspect of user input entered in the no-tap zone is disregarded.

Embodiments of an apparatus for providing for the designation of a no-tap zone on a touch screen display may include at least one processor and at least one memory including computer program code. The at least one memory and the computer program code may be configured to, with the processor, cause the apparatus to provide for display, on a touch screen display, of a first area configured to receive user input; provide for display, on the touch screen display, of a second area configured to receive user input; and designate a portion of the first area as a no-tap zone. At least a contact aspect of user input entered in the no-tap zone would be disregarded. The no-tap zone may border at least a portion of the second area.

In some cases, the memory and computer program code may be further configured to, with the processor, cause the apparatus to remove a designation of the portion of the first area as the no-tap zone in an instance in which the user input entered in the no-tap zone includes a movement aspect. In other cases, the memory and computer program code may be further configured to, with the processor, cause the apparatus to remove a designation of the portion of the first area as the no-tap zone in an instance in which the contact aspect of the user input is received outside of the no-tap zone and a movement aspect and a release aspect of the user input is received within the no-tap zone. In still other cases, the memory and computer program code may be further configured to, with the processor, cause the apparatus to remove a designation of the portion of the first area as the no-tap zone based on the user's interaction with the second area.

The memory and computer program code may be further configured to, with the processor, cause the apparatus to monitor a frequency of a user's interaction with the second area and to remove a designation of the portion of the first area as the no-tap zone based on the frequency and/or cause the apparatus to provide for indication of the no-tap zone to a user. Furthermore, in some embodiments, the memory and computer program code may be further configured to, with the processor, cause the apparatus to designate a portion of the second area as at least part of the no-tap zone. In addition, the memory and computer program code may be further configured to, with the processor, cause the apparatus to dynamically size the no-tap zone based on a user's interaction with the touch screen display over a period of time.

In other embodiments, a method and a computer program product are provided for the designation of a no-tap zone on a touch screen display. The method may include providing for display, on a touch screen display, of a first area configured to receive user input; providing for display, on the touch screen display, of a second area configured to receive user input; and designating a portion of the first area as a no-tap zone, where at least a contact aspect of user input entered in the no-tap zone would be disregarded. The no-tap zone may border at least a portion of the second area.

A designation of the portion of the first area as the no-tap zone may be removed in an instance in which the user input entered in the no-tap zone includes a movement aspect and/or in an instance in which the contact aspect of the user input is received outside of the no-tap zone and a movement aspect and a release aspect of the user input is received within the no-tap zone. In some cases, a designation of the portion of the first area as the no-tap zone may be removed based on a user's interaction with the second area. Furthermore, a frequency of a user's interaction with the second area may be monitored, and a designation of the portion of the first area as the no-tap zone may be removed based on the frequency.

In some cases, the method may include providing for indication of the no-tap zone to a user. A portion of the second area may be designated as at least part of the no-tap zone. Also, the no-tap zone may be dynamically sized based on a user's interaction with the touch screen display over a period of time.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates one example of a communication system according to an example embodiment of the present invention;

FIG. 2 illustrates a schematic block diagram of an apparatus for providing for the designation of a no-tap zone according to an example embodiment of the present invention;

FIG. 3 illustrates an apparatus configured to provide for the designation of a no-tap zone according to an example embodiment of the present invention;

FIG. 4 illustrates an apparatus configured to provide for the designation of a no-tap zone according to another example embodiment of the present invention; and

FIG. 5 illustrates a flowchart of a method of providing for the designation of a no-tap zone in accordance with an example embodiment of the present invention.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a physical storage medium (e.g., volatile or non-volatile memory device), can be differentiated from a “computer-readable transmission medium,” which refers to an electromagnetic signal.

Touch screen displays have been incorporated into many types of devices as a way to obtain input from a user in an easy and intuitive manner. Mobile terminals, for example, are often equipped with touch screen displays. In the case of mobile terminals, such devices have gradually grown smaller in response to the demand for increased portability, to the point where many such devices are roughly the size of a user's hand. The smaller size of such devices has also meant a smaller user interface for receiving user input. For example, in touch screen devices, user input is typically received via the user's contact (e.g., via the user's finger, a stylus, or other implement) with the touch screen display in the form of input gestures. These input gestures may include various aspects of input, including a contact aspect (e.g., the initial contact between the user's finger and the touch screen display), a movement aspect (e.g., the movement of the person's finger across the display), and a release aspect of input (e.g., the separation of the user's finger from the touch screen display upon completion of the input gesture).

Depending on the particular application with which the user is interfacing, the device may provide for the display of different areas on the touch screen display for receiving input and/or displaying data. For example, in a word processing application (which may, e.g., be an e-mail program), a virtual keyboard may be displayed on the touch screen display, and the keyboard may be configured to receive and provide for the execution of operations based on input gestures provided by the user. Often, user interface elements may be located near other interactive elements. In the example of a word processing application, the virtual keyboard may be displayed near the text area, or the area on which the text of the document being edited appears. Thus, an input gesture meant for the virtual keyboard may land inadvertently in the text area, and instead of entering a particular letter into the document, the input gesture in the text area may be interpreted as the user's wish to move a cursor position to the area indicated by the touch. A fast typist or one who is not constantly looking at the area within which the words are entered may neglect to realize that the position of the cursor has been changed in this case, and as a result the user may continue typing, but in the wrong location. This mistake may, for example, occur more often in the area of the touch screen display just above the virtual keyboard.

Accordingly, embodiments of the apparatus, method, and computer program product described below provide for the designation of a no-tap zone on a touch screen display, in which at least a contact aspect of user input entered in the no-tap zone is disregarded. In this way, accidental input gestures made in the no-tap zone (e.g., input gestures meant for entry outside the no-tap zone that miss their mark) may be ignored, and the user can proceed with his interaction with the touch screen display without disruption or the execution of unintended operations, as described in greater detail below.

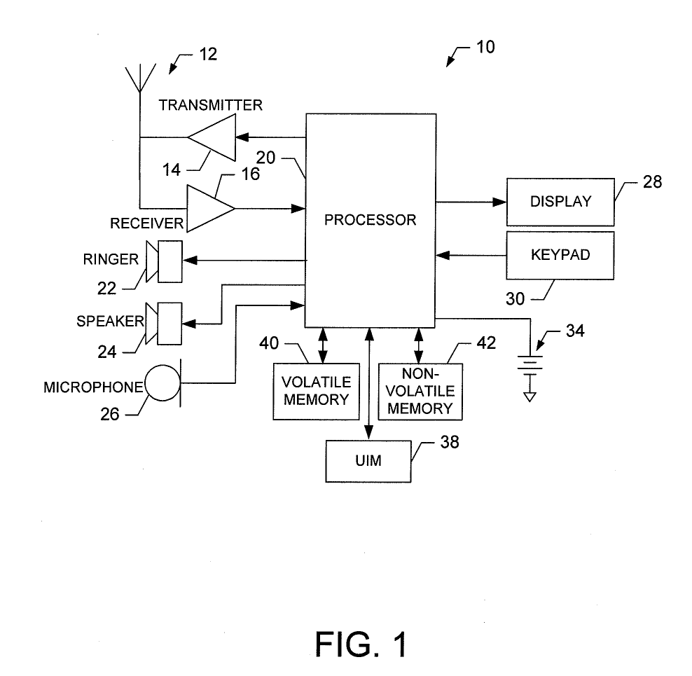

FIG. 1, which provides one example embodiment, illustrates a block diagram of a mobile terminal 10 that would benefit from embodiments of the present invention. It should be understood, however, that the mobile terminal 10 as illustrated and hereinafter described is merely illustrative of one type of device that may benefit from embodiments of the present invention and, therefore, should not be taken to limit the scope of embodiments of the present invention. As such, although numerous types of mobile terminals, such as portable digital assistants (PDAs), mobile telephones, pagers, mobile televisions, gaming devices, laptop computers, cameras, tablet computers, touch surfaces, wearable devices, video recorders, audio/video players, radios, electronic books, positioning devices (e.g., global positioning system (GPS) devices), or any combination of the aforementioned, and other types of voice and text communications systems, may readily employ embodiments of the present invention, other devices including fixed (non-mobile) electronic devices may also employ some example embodiments.

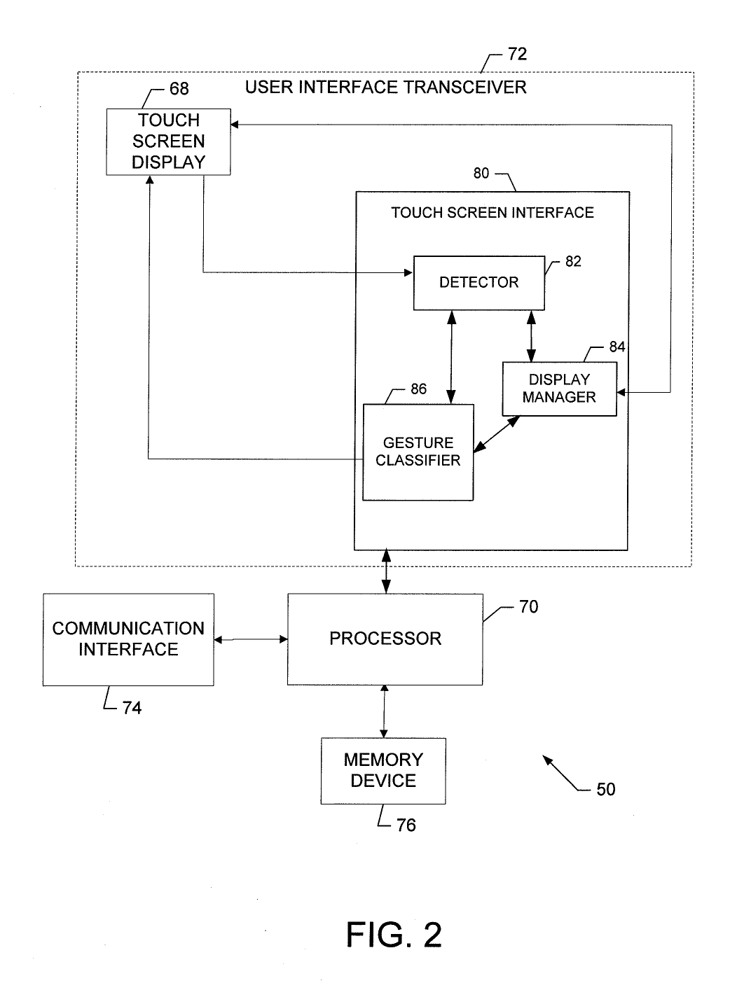

The mobile terminal 10 may include an antenna 12 (or multiple antennas) in operable communication with a transmitter 14 and a receiver 16. The mobile terminal 10 may further include an apparatus, such as a processor 20 or other processing device (e.g., processor 70 of FIG. 2), which controls the provision of signals to and the receipt of signals from the transmitter 14 and receiver 16, respectively. The signals may include signaling information in accordance with the air interface standard of the applicable cellular system, and also user speech, received data and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second, third and/or fourth-generation communication protocols or the like. For example, the mobile terminal 10 may be capable of operating in accordance with second-generation (2G) wireless communication protocols IS-136 (time division multiple access (TDMA)), GSM (global system for mobile communication), and IS-95 (code division multiple access (CDMA)), or with third-generation (3G) wireless communication protocols, such as Universal Mobile Telecommunications System (UMTS), CDMA2000, wideband CDMA (WCDMA) and time division-synchronous CDMA (TD-SCDMA), with 3.9G wireless communication protocol such as evolved UMTS Terrestrial Radio Access Network (E-UTRAN), with fourth-generation (4G) wireless communication protocols (e.g., Long Term Evolution (LTE) or LTE-Advanced (LTE-A) or the like. As an alternative (or additionally), the mobile terminal 10 may be capable of operating in accordance with non-cellular communication mechanisms. For example, the mobile terminal 10 may be capable of communication in a wireless local area network (WLAN) or other communication networks.

In some embodiments, the processor 20 may include circuitry desirable for implementing audio and logic functions of the mobile terminal 10. For example, the processor 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The processor 20 thus may also include the functionality to convolutionally encode and interleave message and data prior to modulation and transmission. The processor 20 may additionally include an internal voice coder, and may include an internal data modem. Further, the processor 20 may include functionality to operate one or more software programs, which may be stored in memory. For example, the processor 20 may be capable of operating a connectivity program, such as a conventional Web browser. The connectivity program may then allow the mobile terminal 10 to transmit and receive Web content, such as location-based content and/or other web page content, according to a Wireless Application Protocol (WAP), Hypertext Transfer Protocol (HTTP) and/or the like, for example.

The mobile terminal 10 may also comprise a user interface including an output device such as a conventional earphone or speaker 24, a ringer 22, a microphone 26, a display 28, and a user input interface, all of which are coupled to the processor 20. The user input interface, which allows the mobile terminal 10 to receive data, may include any of a number of devices allowing the mobile terminal 10 to receive data, such as a keypad 30, a touch screen display (display 28 providing an example of such a touch screen display) or other input device. In embodiments including the keypad 30, the keypad 30 may include the conventional numeric (0-9) and related keys (#, *), and other hard and soft keys used for operating the mobile terminal 10. Alternatively or additionally, the keypad 30 may include a conventional QWERTY keypad arrangement. The keypad 30 may also include various soft keys with associated functions. In addition, or alternatively, the mobile terminal 10 may include an interface device such as a joystick or other user input interface. Some embodiments employing a touch screen display, as described further below, may omit the keypad 30 and any or all of the speaker 24, ringer 22, and microphone 26 entirely. The mobile terminal 10 further includes a battery 34, such as a vibrating battery pack, for powering various circuits that are required to operate the mobile terminal 10, as well as optionally providing mechanical vibration as a detectable output.

The mobile terminal 10 may further include a user identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which may be embedded and/or may be removable. The memories may store any of a number of pieces of information, and data, used by the mobile terminal 10 to implement the functions of the mobile terminal 10.

In some embodiments, the mobile terminal 10 may also include a camera or other media capturing element (not shown) in order to capture images or video of objects, people and places proximate to the user of the mobile terminal 10. However, the mobile terminal 10 (or even some other fixed terminal) may also practice example embodiments in connection with images or video content (among other types of content) that are produced or generated elsewhere, but are available for consumption at the mobile terminal 10 (or fixed terminal).

An example embodiment of the invention will now be described with reference to FIG. 2, in which certain elements of an apparatus 50 for providing for the designation of a no-tap zone on a touch screen display are depicted. The apparatus 50 of FIG. 2 may be employed, for example, in conjunction with the mobile terminal 10 of FIG. 1. However, it should be noted that the apparatus 50 of FIG. 2 may also be employed in connection with a variety of other devices, both mobile and fixed, and therefore, embodiments of the present invention should not be limited to application on devices such as the mobile terminal 10 of FIG. 1. For example, the apparatus 50 may be employed on a personal computer or other user terminal. Moreover, in some cases, the apparatus 50 may be on a fixed device such as server or other service platform and the content may be presented (e.g., via a server/client relationship) on a remote device such as a user terminal (e.g., the mobile terminal 10) based on processing that occurs at the fixed device.

It should also be noted that while FIG. 2 illustrates one example of a configuration of an apparatus for providing for the designation of a no-tap zone, numerous other configurations may also be used to implement embodiments of the present invention. As such, in some embodiments, although devices or elements are shown as being in communication with each other, hereinafter such devices or elements should be considered to be capable of being embodied within a same device or element and thus, devices or elements shown in communication should be understood to alternatively be portions of the same device or element.

Referring now to FIG. 2, the apparatus 50 for providing for the designation of a no-tap zone on a touch screen display may include or otherwise be in communication with a processor 70, a user interface transceiver 72, a communication interface 74, and a memory device 76. In some embodiments, the processor 70 (and/or co-processors or any other processing circuitry assisting or otherwise associated with the processor 70) may be in communication with the memory device 76 via a bus for passing information among components of the apparatus 50. The memory device 76 may include, for example, one or more volatile and/or non-volatile memories. In other words, for example, the memory device 76 may be an electronic storage device (e.g., a computer readable storage medium) comprising gates configured to store data (e.g., bits) that may be retrievable by a machine (e.g., a computing device like the processor 70). The memory device 76 may be configured to store information, data, content, applications, instructions, or the like for enabling the apparatus to carry out various functions in accordance with an example embodiment of the present invention. For example, the memory device 76 could be configured to buffer input data for processing by the processor 70. Additionally or alternatively, the memory device 76 could be configured to store instructions for execution by the processor 70.

The apparatus 50 may, in some embodiments, be a mobile terminal (e.g., mobile terminal 10) or a fixed communication device or computing device configured to employ an example embodiment of the present invention. However, in some embodiments, the apparatus 50 may be embodied as a chip or chip set. In other words, the apparatus 50 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 50 may therefore, in some cases, be configured to implement an embodiment of the present invention on a single chip or as a single “system on a chip.” As such, in some cases, a chip or chipset may constitute means for performing one or more operations for providing the functionalities described herein.

The processor 70 may be embodied in a number of different ways. For example, the processor 70 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 70 may include one or more processing cores configured to perform independently. A multi-core processor may enable multiprocessing within a single physical package. Additionally or alternatively, the processor 70 may include one or more processors configured in tandem via the bus to enable independent execution of instructions, pipelining and/or multithreading.

In an example embodiment, the processor 70 may be configured to execute instructions stored in the memory device 76 or otherwise accessible to the processor 70. Alternatively or additionally, the processor 70 may be configured to execute hard coded functionality. As such, whether configured by hardware or software methods, or by a combination thereof, the processor 70 may represent an entity (e.g., physically embodied in circuitry) capable of performing operations according to an embodiment of the present invention while configured accordingly. Thus, for example, when the processor 70 is embodied as an ASIC, FPGA or the like, the processor 70 may be specifically configured hardware for conducting the operations described herein. Alternatively, as another example, when the processor 70 is embodied as an executor of software instructions, the instructions may specifically configure the processor 70 to perform the algorithms and/or operations described herein when the instructions are executed. However, in some cases, the processor 70 may be a processor of a specific device (e.g., a mobile terminal or network device) adapted for employing an embodiment of the present invention by further configuration of the processor 70 by instructions for performing the algorithms and/or operations described herein. The processor 70 may include, among other things, a clock, an arithmetic logic unit (ALU) and logic gates configured to support operation of the processor 70.

Meanwhile, the communication interface 74 may be any means such as a device or circuitry embodied in either hardware or a combination of hardware and software that is configured to receive and/or transmit data from/to a network and/or any other device or module in communication with the apparatus 50. In this regard, the communication interface 74 may include, for example, an antenna (or multiple antennas) and supporting hardware and/or software for enabling communications with a wireless communication network. Additionally or alternatively, the communication interface 74 may include the circuitry for interacting with the antenna(s) to cause transmission of signals via the antenna(s) or to handle receipt of signals received via the antenna(s). In some environments, the communication interface 74 may alternatively or also support wired communication. As such, for example, the communication interface 74 may include a communication modem and/or other hardware/software for supporting communication via cable, digital subscriber line (DSL), universal serial bus (USB) or other mechanisms.

The user interface transceiver 72 may be in communication with the processor 70 to receive an indication of a user input and/or to cause provision of an audible, visual, mechanical or other output to the user. As such, the user interface transceiver 72 may include, for example, a keyboard, a mouse, a joystick, a display, a touch screen(s), touch areas, soft keys, a microphone, a speaker, or other input/output mechanisms. Alternatively or additionally, the processor 70 may comprise user interface circuitry configured to control at least some functions of one or more user interface elements such as, for example, a speaker, ringer, microphone, display, and/or the like. The processor 70 and/or user interface circuitry comprising the processor 70 may be configured to control one or more functions of one or more user interface elements through computer program instructions (e.g., software and/or firmware) stored on a memory accessible to the processor 70 (e.g., memory device 76, and/or the like).

In an example embodiment, the apparatus 50 may include or otherwise be in communication with a touch screen display 68 (e.g., the display 28). In different example cases, the touch screen display 68 may be a two dimensional (2D) or three dimensional (3D) display. The touch screen display 68 may be embodied as any known touch screen display. Thus, for example, the touch screen display 68 could be configured to enable touch recognition by any suitable technique, such as resistive, capacitive, infrared, strain gauge, surface wave, optical imaging, dispersive signal technology, acoustic pulse recognition, and/or other techniques. The user interface transceiver 72 may be in communication with the touch screen display 68 to receive indications of user inputs at the touch screen display 68 and to modify a response to such indications based on corresponding user actions that may be inferred or otherwise determined responsive to the indications.

In an example embodiment, the apparatus 50 may include a touch screen interface 80. The touch screen interface 80 may, in some instances, be a portion of the user interface transceiver 72. However, in some alternative embodiments, the touch screen interface 80 may be embodied as the processor 70 or may be a separate entity controlled by the processor 70. As such, in some embodiments, the processor 70 may be said to cause, direct or control the execution or occurrence of the various functions attributed to the touch screen interface 80 (and any components of the touch screen interface 80) as described herein. The touch screen interface 80 may be any means such as a device or circuitry operating in accordance with software or otherwise embodied in hardware or a combination of hardware and software (e.g., processor 70 operating under software control, the processor 70 embodied as an ASIC or FPGA specifically configured to perform the operations described herein, or a combination thereof) thereby configuring the device or circuitry to perform the corresponding functions of the touch screen interface 80 as described herein. Thus, in examples in which software is employed, a device or circuitry (e.g., the processor 70 in one example) executing the software forms the structure associated with such means.

The touch screen interface 80 may be configured to receive an input in the form of a touch event at the touch screen display 68. As such, the touch screen interface 80 may be in communication with the touch screen display 68 to receive user inputs at the touch screen display 68 and to modify a response to such inputs based on corresponding user actions that may be inferred or otherwise determined responsive to the indications. Following recognition of a touch event, the touch screen interface 80 may be configured to determine a classification of the touch event and provide a corresponding function based on the touch event in some situations.

In some embodiments, the touch screen interface 80 may include a detector 82, a display manager 84, and a gesture classifier 86. Each of the detector 82, the display manager 84, and the gesture classifier 86 may be any device or means embodied in either hardware or a combination of hardware and software configured to perform the corresponding functions associated with the detector 82, the display manager 84, and the gesture classifier 86, respectively, as described herein. In an exemplary embodiment, each of the detector 82, the display manager 84, and the gesture classifier 86 may be controlled by or otherwise embodied as the processor 70.

The detector 82 may be in communication with the touch screen display 68 to receive indications of user inputs in order to recognize and/or determine a touch event based on each input received at the detector 82. A touch event may be defined as a detection of an object, such as a stylus, finger, pen, pencil or any other pointing device, coming into contact with a portion of the touch screen display in a manner sufficient to register as a touch. In this regard, for example, a touch event could be a detection of pressure on the screen of the touch screen display 68 above a particular pressure threshold over a given area. Subsequent to each touch event, the detector 82 may be further configured to pass along the data corresponding to the touch event (e.g., location of touch, length of touch, number of objects touching, touch pressure, speed of movement, direction of movement, length of delay, frequency of touch, etc.) to the gesture classifier 86 for gesture classification. As noted above, the touch event (e.g., in the form of an input gesture) may include different aspects of input, including a contact aspect, a movement aspect, and a release aspect. Thus, the detector 82 may further be configured to detect and process such aspects of the input gesture and/or to pass the aspects along to the gesture classifier 86.

The gesture classifier 86 may be configured to recognize and/or determine a corresponding classification of a touch event. In other words, the gesture classifier 86 may be configured to perform gesture classification to classify the touch event as any of a number of possible gestures. Some examples of recognizable gestures may include a touch, multi-touch, stroke, character, symbol, shape, swipe, pinch event (e.g., a pinch in or pinch out), and/or the like.

A touch may be defined as a touch event that impacts a single area (without or with minimal movement on the surface of the touch screen display 68) and then is removed. A multi-touch may be defined as multiple touch events sensed concurrently (or nearly concurrently). Thus, touches and multi-touches may involve only a contact aspect and a release aspect of input. A stroke event may be defined as a touch event followed by motion of the object initiating the touch event while the object remains in contact with the touch screen display 68. In other words, the stroke event may be defined by motion following a touch event thereby forming a continuous, moving touch event defining a moving series of instantaneous touch positions (e.g., as a swipe, a drag operation, or a flick operation). As such, a stroke event may include a contact aspect, a movement aspect, and a release aspect of input. Multiple strokes and/or touches may be used to define a particular shape or sequence of shapes to define a character. A pinch event may be classified as either a pinch out or a pinch in (hereinafter referred to simply as a pinch). A pinch may be defined as a multi-touch, where the touch events causing the multi-touch are spaced apart. After initial occurrence of the multi-touch event involving at least two objects (e.g., the contact aspect of input), one or more of the objects may move substantially toward each other to simulate a pinch (e.g., the movement and release aspects of input). Meanwhile, a pinch out may be defined as a multi-touch, where the touch events causing the multi-touch are relatively close together, followed by movement of the objects initiating the multi-touch substantially away from each other. In some cases, the objects on a pinch out may be so close together initially that they may be interpreted as a single touch, rather than a multi-touch, which then is modified by movement of two objects away from each other.

The gesture classifier 86 may also be configured to communicate detection information regarding the recognition, detection, and/or classification of a touch event to the display manager 84. The display manager 84 may be configured to provide control over modifications made to that which is displayed on the touch screen display 68 based on the detection information received from the detector 82 and gesture classifications provided by the gesture classifier 86 in accordance with the responses prescribed for each respective gesture classification and implementation characteristic determined by the gesture classifier 86. In other words, the display manager 84 may configure the display (e.g., with respect to the content displayed and/or the user interface effects presented relative to the content displayed) according to the gesture classification and implementation characteristic classification determined for a given touch event that may be detected at the display.

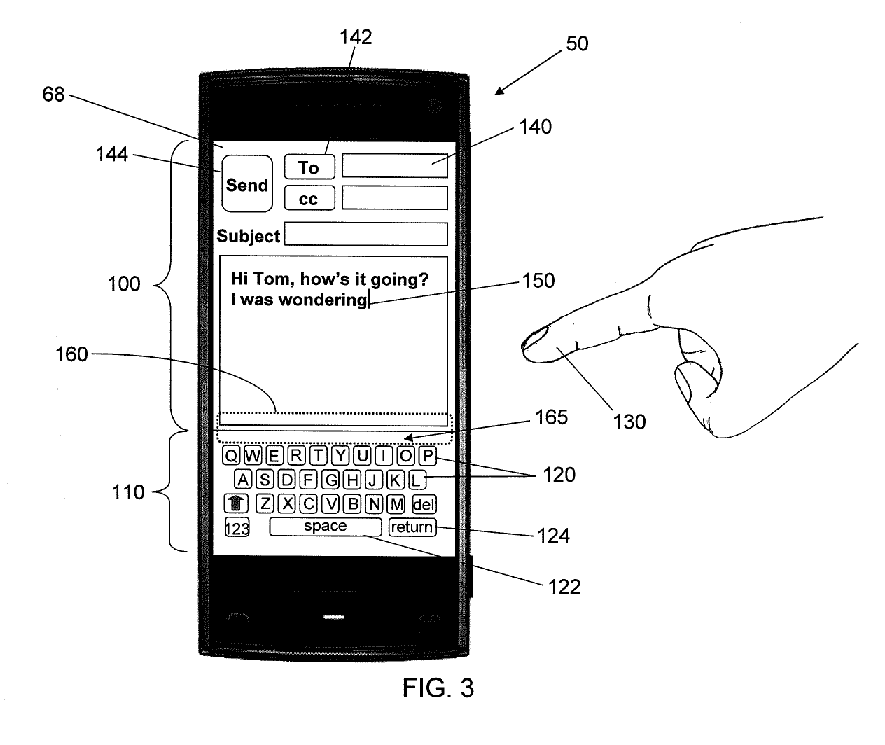

Turning now to FIG. 3, in general, an apparatus 50, such as the mobile terminal 10 of FIG. 1, is provided that has a touch screen display 68. As described above, the apparatus 50 may comprise at least one processor (e.g., processor 70 of FIG. 2) and at least one memory (e.g., memory device 76 of FIG. 2) including computer program code. The at least one memory and the computer program code may be configured to, with the processor, cause the apparatus 50 to provide for display, on the touch screen display 68, of a first area 100 configured to receive user input and a second area 110 configured to receive user input. Each of the first and second areas 100, 110 may include different user interface elements that the user may be able to interact with, e.g., through the use of the input gestures described above.

Considering the example of a word processing application, the first area may be, for example, the body of a document in which text is displayed for review and edit by the user, whereas the second area 110 may be a virtual keyboard that the user may interact with to type text into the first area. In particular, the example depicted in FIG. 3 shows an e-mail application, in which the e-mail itself is at least partially displayed in the first area 100 and the keys 120 for entering and editing the text of the e-mail are displayed in the second area 110. A user in the depicted example may use a finger 130 to interact with the first area 100 to execute operations such as opening a Contacts list for populating the address line 140 by selecting the “To” button 142, sending the e-mail by selecting the “Send” button 144, or positioning a cursor 150 in a particular spot in the e-mail for text entry, among other functions. Similarly, the user may use his finger 130 to interact with the second area 110, such as to select various letters for typing text in the first area and switching between an alphabetic keys and numeric keys.

The at least one memory and computer program code may thus be configured to, with the processor, cause the apparatus to designate a portion of the first area 100 as a no-tap zone 160, where at least a contact aspect of user input entered in the no-tap zone would be disregarded. In other words, the contact aspect of an input gesture occurring in the no-tap zone would be disregarded by the apparatus 50 as a request to execute any operation, and as a result no action would be taken. As illustrated in FIG. 3, in some embodiments the no-tap zone 160 may border at least a portion of the second area 110, so as to cover a portion of the first area proximate the edge of the second area, which may be more prone to errant input gestures due to overshooting of, for example, a top row of keys 120.

As shown in FIG. 3, in some cases the memory and computer program code are further configured to, with the processor, cause the apparatus to designate a portion 165 of the second area 110 as at least part of the no-tap zone. In other words, there may be space provided in the second area 110 between the upper row of keys 120 and the adjacent edge of the first area 100 which, although not indicated as being responsive to input gestures, may actually be an extension of the closest keys. Thus, a user input received, for example, just above the letter “T,” but within the second area, may conventionally effect the entry of a “T” in the document. By designating this portion 165 of the second area 110 as part of the no-tap zone 160, however, inadvertent input gestures received in this area may likewise be disregarded by the apparatus 50.

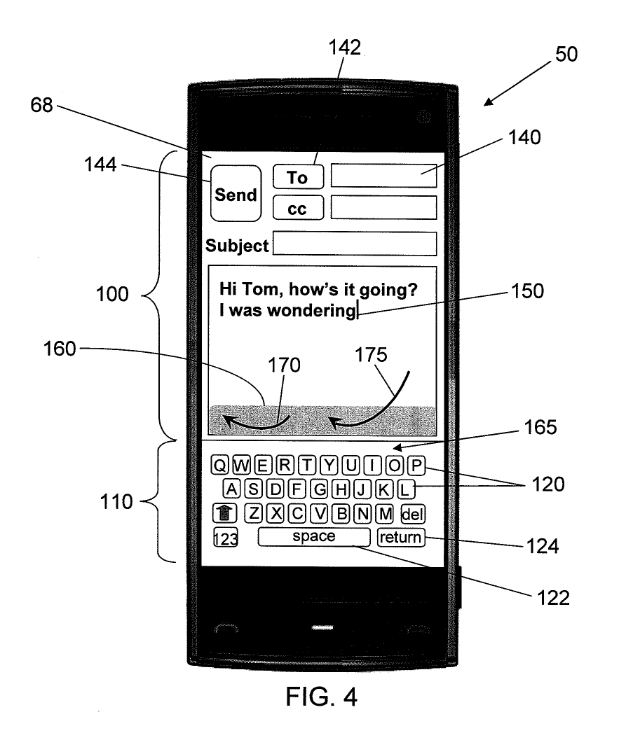

In some embodiments, the memory and computer program code may be further configured to, with the processor, cause the apparatus 50 to provide for indication of the no-tap zone 160 to the user. With reference to FIG. 4, for example, in which the no-tap zone 160 does not extend into the second area (in contrast to the no-tap zone depicted in FIG. 3), the portion designated as the no-tap zone 160 may be indicated by a blurring of the information presented in the effected area, different shading (as shown in FIG. 4), different lighting, or other visual distinctions. Such visual distinctions may thus allow the user to differentiate between areas of the touch screen display 68 that are responsive to the user's input gestures and the no-tap zone 160, which is not.

The memory and computer program code may be further configured to, with the processor, cause the apparatus 50 to remove a designation of the portion of the first area 100 as the no-tap zone 160 in an instance in which the user input entered in the no-tap zone includes a movement aspect. In other words, an input gesture such as a swipe (the path of which is indicated by the arrow 170 in FIG. 4) may include, in addition to a contact aspect, a movement aspect, as described above. The detection of the movement aspect within the no-tap zone 160 may thus be interpreted as an input requesting the removal of the designation of the no-tap zone, such that contact aspects of subsequent input gestures entered in the (former) no-tap zone 160 may be received and acted upon. For example, if the user wishes to place the cursor 150 in a position that is within the no-tap zone 160, the user may swipe his finger 130 (such as along the direction shown by the arrow 170), starting at a point within the no-tap zone 160 and ending at a different point within the no-tap zone 160. As a result, the no-tap zone 160 may be undesignated, and the position at which the user's finger 130 is removed from contact with the touch screen display 68 may be the new position of the cursor 150 for subsequent text entry. Furthermore, additional touch gestures received within the formerly designated no-tap zone 160, including or not including a movement aspect, may be fully recognized (e.g., not disregarded) and acted upon.

Similarly, the apparatus 50 may be configured such that other conditions may remove the designation of the no-tap zone 160. For example, the apparatus 50 may be caused to remove a designation of the portion of the first area 100 as the no-tap zone 160 in an instance in which the contact aspect of the user input is received outside of the no-tap zone and a movement aspect and a release aspect of the user input is received within the no-tap zone, e.g., according to the swipe gesture depicted by the arrow 175 in FIG. 4. In other cases, the no-tap zone 160 may have a predefined duration, such that, once designated, the no-tap zone exists only for a certain amount of time (e.g., fades away). The duration time period may be renewed each time the user interacts with the second area 110, for example by typing certain keys 120. In other words, the designation of the portion of the first area 100 as the no-tap zone 160 may be removed based on the user's interaction with the second area 110. Thus, if the user is typing a steady stream of words using the keys 120, the no-tap zone 160 may continue to be designated; however, if the user pauses from his typing for a certain amount of time (such as two seconds), the designation of the no-tap zone 160 may be removed. As another example, the user's interaction with certain keys 120, such as the spacebar 122 or the return key 124 may trigger the removal of the no-tap zone 160, as interaction with such keys may indicate that the user has finished typing a word or sentence and may want to move the position of the cursor 150.

In some cases, the predefined time period in which the no-tap zone 160 is maintained between interactions with the second area 110 may be defined by the user or application, and in other cases the time period may be based on an observed rate of interaction by the user (e.g., the user's typing rate over the last several seconds). Said differently, the memory apparatus may be configured to, with the processor, cause the apparatus 50 to monitor a frequency of a user's interaction with the second area 110 and to remove a designation of the portion of the first area 100 as the no-tap zone 160 based on the frequency.

Also, in some embodiments, the size of the no-tap zone 160 may be configured according to the user's preferences or according to the overall size of the first and second areas 100, 110 or the apparatus 50 itself. For example, the no-tap zone 160 may have a fixed size, such as 50 pixels or 10 mm Similarly, the size of the no-tap zone 160 may be based on the size of the user interface elements (e.g., the keys 120) displayed in the second area 110. Thus, the no-tap zone 160 may, in some cases, be sized to be 1.5 times the size of a key 120.

In still other embodiments, the memory and computer program code may be further configured to, with the processor, cause the apparatus 50 to dynamically size the no-tap zone 160 based on a user's interaction with the touch screen display 68 over a period of time. For example, a history of the user's interaction with the touch screen display 68 (e.g., the first area 100 and/or the second area 110), or multiple users' interactions, may be monitored. In this way, the location of the cursor at the time that a corrective activity occurs (such as when the user repositions the cursor 150 immediately after typing a letter, indicating a likely accidental input gesture in the first area 100) may define or at least partially inform the size of the no-tap zone 160. Thus, the no-tap zone 160 can be customized to the particular user's needs to protect against errant input gestures in the first area 100.

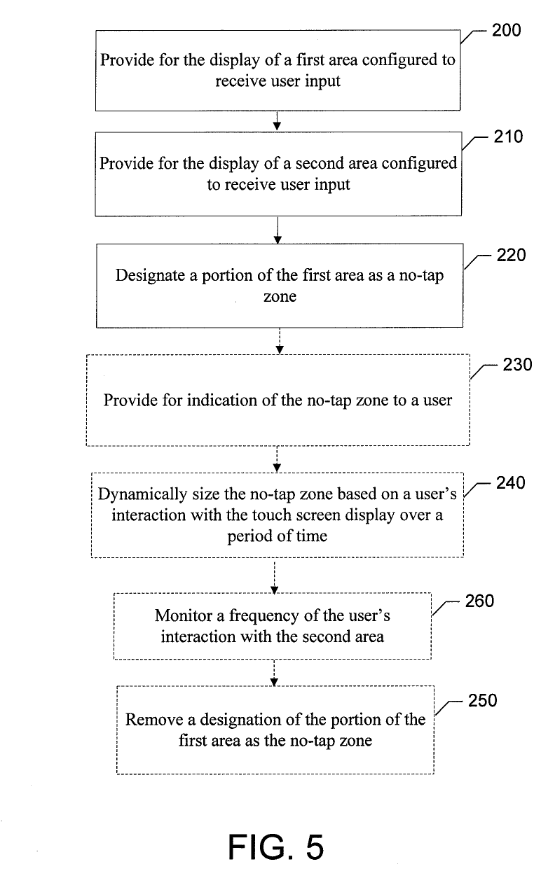

FIG. 5 illustrates a flowchart of a system, method, and computer program product according to example embodiments of the invention. It will be understood that each block of the flowchart, and combinations of blocks in the flowchart, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by a memory device of an apparatus employing an embodiment of the present invention and executed by a processor in the apparatus. As will be appreciated, any such computer program instructions may be loaded onto a computer or other programmable apparatus (e.g., hardware) to produce a machine, such that the resulting computer or other programmable apparatus implements the functions specified in the flowchart block(s). These computer program instructions may also be stored in a computer-readable memory that may direct a computer or other programmable apparatus to function in a particular manner, such that the instructions stored in the computer-readable memory produce an article of manufacture the execution of which implements the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart block(s).

Accordingly, blocks of the flowchart support combinations of means for performing the specified functions, combinations of operations for performing the specified functions, and program instruction means for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In this regard, one embodiment of a method for providing for the designation of a no-tap zone on a touch screen display, in which at least a contact aspect of the user input entered in the no-tap zone is disregarded, as shown in FIG. 5, includes providing for display, on a touch screen display, of a first area configured to receive user input at operation 200, providing for display, on the touch screen display, of a second area configured to receive user input at operation 210, and designating a portion of the first area as a no-tap zone at operation 220, wherein at least a contact aspect of the user input entered in the no-tap zone would be disregarded. As described above and illustrated in FIGS. 3 and 4, the no-tap zone may be designated in an area that borders at least a portion of the second area. In some cases, a portion of the second area may be designated as at least part of the no-tap zone, as shown in FIG. 3.

An indication of the no-tap zone may be provided to a user at operation 230 (illustrated in FIG. 4). Furthermore, the no-tap zone may be dynamically sized based on a user's interaction with the touch screen display over a period of time at operation 240.

In some embodiments, the designation of the portion of the first area as the no-tap zone may be removed at operation 250 for various reasons. For example, the designation may be removed in an instance in which the user input entered in the no-tap zone includes a movement aspect. In other cases, the designation may be removed in an instance in which the contact aspect of the user input is received outside of the no-tap zone and a movement aspect and a release aspect of the user input is received within the no-tap zone.

In still other cases, the designation of the portion of the first area as the no-tap zone may be removed based on the user's interaction with the second area. For example, a frequency of a user's interaction with the second area may be monitored at operation 260, and the designation may be removed based on the frequency at operation 250.

In some embodiments, certain ones of the operations above may be modified or further amplified as described below. Furthermore, in some embodiments, additional optional operations may be included, some examples of which are shown in dashed lines in FIG. 5. Modifications, additions, or amplifications to the operations above may be performed in any order and in any combination.

In an example embodiment, an apparatus for performing the method of FIG. 5 above may comprise a processor (e.g., the processor 70 of FIG. 2) configured to perform some or each of the operations (200-260) described above. The processor may, for example, be configured to perform the operations (200-260) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 200-230 and 250 may comprise, for example, the processor 70, the user interface transceiver 72, and/or a device or circuit for executing instructions or executing an algorithm for processing information as described above. Moreover, examples of means for performing at least portions of operations 240 and 260 may comprise, for example, the processor 70, the user interface transceiver 72, the memory device 76, and/or a device or circuit for executing instructions or executing an algorithm for processing information as described above.

Many modifications and other embodiments of the inventions set forth herein will come to mind to one skilled in the art to which these inventions pertain having the benefit of the teachings presented in the foregoing descriptions and the associated drawings. For example, the scenarios described above are provided in the context of mobile terminals; however, embodiments of the present invention are applicable to touch screen displays on a variety of devices, both mobile and fixed. Furthermore, although the examples above describe embodiments of the invention in the context of a word processing application, such as an e-mail application, it is recognized that the display of the first and second areas may be provided for in any number of applications in which different areas with different user interface elements are provided, including imaging applications, music applications, multi-media applications, and so on. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. An apparatus comprising at least one processor and at least one memory including computer program code, the at least one memory and the computer program code configured to, with the processor, cause the apparatus to at least:
provide for display, on a touch screen display, of a first area configured to receive user input;
provide for display, on the touch screen display, of a second area configured to receive user input; and
designate a portion of the first area as a no-tap zone,
wherein the no-tap zone borders at least a portion of the second area, and wherein at least a contact aspect of user input entered in the no-tap zone would be disregarded.

2. The apparatus of claim 1, wherein the memory and computer program code are further configured to, with the processor, cause the apparatus to remove a designation of the portion of the first area as the no-tap zone in an instance in which the user input entered in the no-tap zone includes a movement aspect.

3. The apparatus of claim 1, wherein the memory and computer program code are further configured to, with the processor, cause the apparatus to remove a designation of the portion of the first area as the no-tap zone in an instance in which the contact aspect of the user input is received outside of the no-tap zone and a movement aspect and a release aspect of the user input is received within the no-tap zone.

4. The apparatus of claim 1, wherein the memory and computer program code are further configured to, with the processor, cause the apparatus to remove a designation of the portion of the first area as the no-tap zone based on the user's interaction with the second area.

5. The apparatus of claim 1, wherein the memory and computer program code are further configured to, with the processor, cause the apparatus to monitor a frequency of a user's interaction with the second area and to remove a designation of the portion of the first area as the no-tap zone based on the frequency.

6. The apparatus of claim 1, wherein the memory and computer program code are further configured to, with the processor, cause the apparatus to provide for indication of the no-tap zone to a user.

7. The apparatus of claim 1, wherein the memory and computer program code are further configured to, with the processor, cause the apparatus to designate a portion of the second area as at least part of the no-tap zone.

8. The apparatus of claim 1, wherein the memory and computer program code are further configured to, with the processor, cause the apparatus to dynamically size the no-tap zone based on a user's interaction with the touch screen display over a period of time.

9. A method comprising:
providing for display, on a touch screen display, of a first area configured to receive user input;
providing for display, on the touch screen display, of a second area configured to receive user input; and
designating a portion of the first area as a no-tap zone,
wherein the no-tap zone borders at least a portion of the second area, and wherein at least a contact aspect of user input entered in the no-tap zone would be disregarded.

10. The method of claim 9 further comprising removing a designation of the portion of the first area as the no-tap zone in an instance in which the user input entered in the no-tap zone includes a movement aspect.

11. The method of claim 9 further comprising removing a designation of the portion of the first area as the no-tap zone in an instance in which the contact aspect of the user input is received outside of the no-tap zone and a movement aspect and a release aspect of the user input is received within the no-tap zone.

12. The method of claim 9 further comprising removing a designation of the portion of the first area as the no-tap zone based on a user's interaction with the second area.

13. The method of claim 9 further comprising monitoring a frequency of a user's interaction with the second area and removing a designation of the portion of the first area as the no-tap zone based on the frequency.

14. The method of claim 9 further comprising providing for indication of the no-tap zone to a user.

15. The method of claim 9 further comprising designating a portion of the second area as at least part of the no-tap zone.

16. The method of claim 9 further comprising dynamically sizing the no-tap zone based on a user's interaction with the touch screen display over a period of time.

17. A computer program product comprising at least one computer-readable storage medium having computer-executable program code portions stored therein, the computer-executable program code portions comprising program code instructions for:
providing for display, on a touch screen display, of a first area configured to receive user input;
providing for display, on the touch screen display, of a second area configured to receive user input; and
designating a portion of the first area as a no-tap zone,
wherein the no-tap zone borders at least a portion of the second area, and wherein at least a contact aspect of user input entered in the no-tap zone would be disregarded.

18. The computer program product of claim 17 further comprising program code instructions for removing a designation of the portion of the first area as the no-tap zone in an instance in which the user input entered in the no-tap zone includes a movement aspect.

19. The computer program product of claim 17 further comprising program code instructions for removing a designation of the portion of the first area as the no-tap zone based on a user's interaction with the second area.

20. The computer program product of claim 17 further comprising program code instructions for dynamically sizing the no-tap zone based on a user's interaction with the touch screen display over a period of time.
